(19) United States
(12) Patent Application Publication
(10) Pub. No.: US 2016/0276740 A1
(43) Pub. Date: Sep. 22, 2016

(54) MULTI-ANTENNA BROADBAND SYSTEM CONSISTING OF AT LEAST TWO ANTENNAS WITH THE SAME FORM AND THE SAME SIZE

(71) Applicant: AVIWEST, Saint Gregoire Cedex 9 (FR)

(72) Inventors: Jean-Michel MONTEIX, CESSON SEVIGNE (FR); Jean-Marie FLOC'H, RENNES (FR)

(21) Appl. No.: 14/778,344

(22) PCT Filed: Mar. 17, 2014
(86) PCT No.: PCT/EP2014/055315

§ 371 Date: Sep. 18, 2015

(30) Foreign Application Priority Data
Mar. 20, 2013 (FR) 13/52500

(51) Int. Cl. H01Q 1/36; H01Q 21/06; H01Q 1/48

(52) U.S. Cl. CPC H01Q 1/36; H01Q 1/48; H01Q 21/061

(57) ABSTRACT

A multi-antenna broadband system may include at least two antennas with the same shape and same size, placed above an earth plane, wherein the antennas are connected respectively to a modem, and the part most distant from the earth plane of each antenna is folded one or more times so that the folded part or the last folded part of the antenna forms an angle with the non-folded part of the antenna of between 10° and 100°.

The present invention relates to a multisystem multi-antenna broadband system consisting of at least two antennas with the same form and the same dimensions,

Current portable telecommunication devices, such as for example mobile telephones, communicating tablets or remote metering devices, must be capable of transmitting and/or receiving signals in a plurality of frequency bands.

For example, the new telecommunication standard 3GPP LTE, also referred to as 4G, opens up a large number of frequency sub-bands in which the telecommunication devices must transmit and/or receive signals. The frequency sub-bands are between 700 MHz and 2700 MHz. The frequency sub-band 700 to 800 MHz, the frequency sub-band 824 to 960 MHz and the frequency sub-bands between 1710 MHz and 2700 MHz are examples.

The antenna or antennas of portable telecommunication devices must be able to transmit and/or receive electromagnetic signals in these frequency sub-bands. The lowest frequency sub-bands require large antennas while the miniaturisation of portable telecommunication devices imposes requirements of compactness on antennas.

The aim of the present invention is to solve these various constraints by proposing a multi-antenna system that is able to radiate and/or convert electromagnetic waves in a wide frequency spectrum while being compact.

To this end, according to a first aspect, the invention proposes a multi-antenna broadband system consisting of at least two antennas with the same form and the same dimensions, placed above an earth plane, characterised in that the antennas are connected respectively to a modem, and the most distant part of the earth plane of each antenna is folded once or several times so that the folded part or the last folded part of the antenna forms an angle with the non-folded part of the antenna of between 10° and 100°.

Thus the multi-antenna system is able to radiate and/or convert electromagnetic waves in a wide frequency spectrum while being compact.

By virtue of the fold or folds produced, the size of the multi-antenna system is reduced and the couplings between the antennas are reduced compared with the multi-antenna broadband systems known to persons skilled in the art.

By virtue of the fold or folds produced and the combination of at least two antennas according to the present invention, the dimensions of the earth plane on which the antennas are placed have little influence on the matching and radiation characteristics, whether the earth plane be wider or thicker, or whether the earth plane be placed or fixed on a substrate, for example against a wall, on the metal roof of a vehicle or on a wooden table.

By virtue of the fold or folds produced, the positioning of each of the two antennas and the combination of at least two antennas according to the present invention, the dimensions of the earth plane will be reduced compared with the dimensions that the earth plane would have on which a single antenna or a plurality of antennas designed with the existing current solutions and within the capability of a person skilled in the art would be mounted.

According to a particular embodiment of the invention, each antenna is folded once and the length of the folded part of the antenna represents between 25% and 40% of the total length of the antenna.

Thus the directivity of the antennas of the multi-antenna system is improved. By choosing such a length, a capacitive coupling between the folded parts of the antennas and the earth plane is obtained. The capacitive coupling obtained makes it possible to reduce the existing coupling between the various antennas and makes it possible to reduce the size of the multi-antenna system.

This same capacitive coupling stabilises the behaviour of the multi-antenna system vis-a-vis its environment.

According to a particular embodiment of the invention, each antenna is placed above the earth plane at the same distance from the earth plane and at the same distance from the centre of the earth plane.

According to a particular embodiment of the invention, the multi-antenna system comprises an even number of antennas, and each antenna is symmetrical with another antenna in accordance with a central symmetry, the centre of the symmetry being a point above the earth plane at the same distance as the distance separating the antennas from the earth plane.

Thus the directivity of each of the antennas in the multi-antenna system, compared with a system provided with conventional antennas, is improved, and the coupling existing between the various antennas is reduced.

According to a particular embodiment of the invention, each antenna is placed above the earth plane at a position such that the distance from its symmetrical antenna is the greatest.

According to a particular embodiment of the invention, the multi-antenna system comprises an odd number of antennas comprising a first antenna and second antennas, the first antenna being placed at a point above the earth plane at the same distance from the earth plane as the distance from the antennas to the earth plane and each second antenna is symmetrical with another second antenna in accordance with a central symmetry, the centre of the symmetry being the point at which the first antenna is placed.

Thus the directivity of the multi-antenna system is improved, and the coupling existing between the various antennas is reduced.

This configuration is particularly advantageous if the frequency band in which the first antenna functions is different from the frequency band in which the second antennas function.

According to a particular embodiment of the invention, each second antenna is placed above the earth plane at a position such that the distance from its symmetrical antenna is the greatest.

Thus the directivity of the multi-antenna system is improved and the coupling existing between the various antennas is reduced.

According to a particular embodiment of the invention, the antennas have a circular, triangular, trapezoidal or elliptical shape and are placed above the earth plane at a distance of 1 to 4 mm from the earth plane.

According to a particular embodiment of the invention, the shape is elliptical and the total length of the antenna is 70 mm.

The features of the invention mentioned above, as well as others, will emerge more clearly from a reading of the following description of an example embodiment, said description being given in relation to the accompanying drawings, among which:

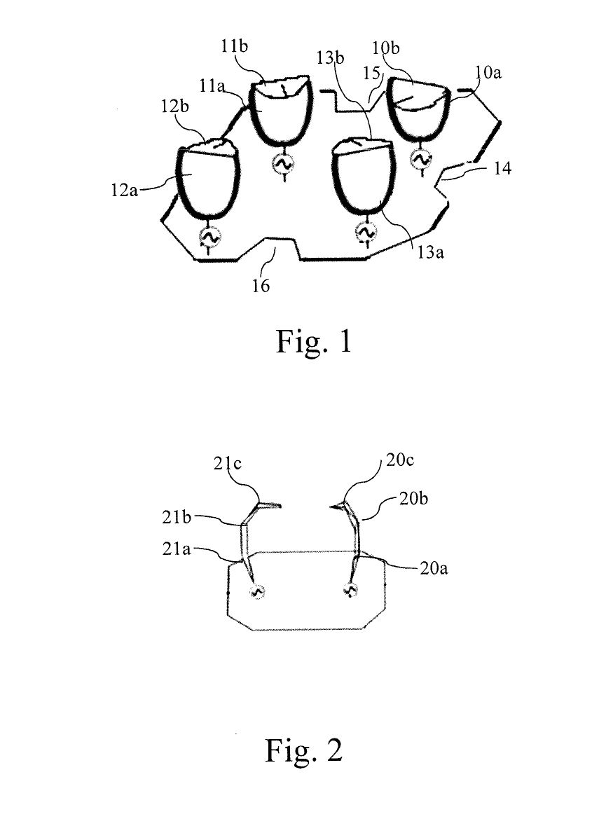

FIG. 1 shows an example embodiment of a multi-antenna system that comprises an even number of antennas;

FIG. 2 shows a second example embodiment of a multi-antenna system according to the present invention;

FIG. 2 shows a longitudinal section of two antennas that are symmetrical with respect to a point.

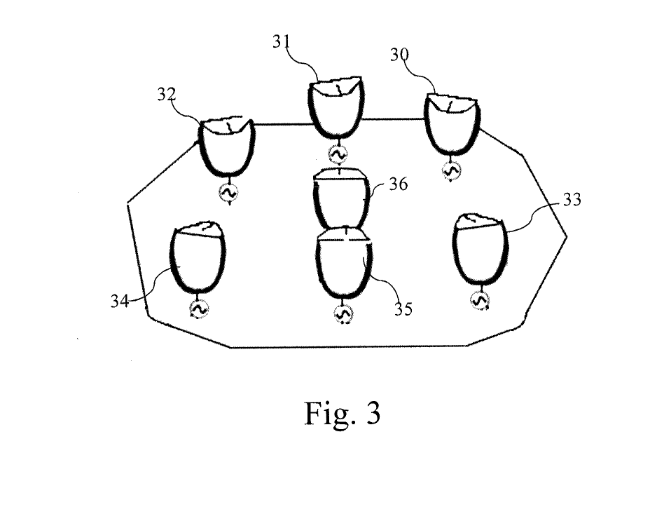

FIG. 3 shows an example embodiment of a multi-antenna system that comprises an odd number of antennas.

FIG. 1 shows an example embodiment of a multi-antenna system that comprises an even number of antennas.

In the example in FIG. 1, the multi-antenna system comprises four antennas. The antennas have the same shape and the same size.

The antennas have an elliptical shape and are placed above the earth plane at a distance of 1 to 4 mm, preferentially 2 mm, from the earth plane. In a variant, the antennas have a circular, triangular, trapezoidal or elliptical shape.

The antennas are connected respectively to a modem represented by a sinusoid in a circle.

The part 10b, 11b, 12b and 13b most distant from the earth plane of each antenna is folded once so that the folded part 10b, 11b, 12b and 13b of the antenna forms an angle with the non-folded part of the antenna of between 10° and 100°. Preferentially, the angle is 90°.

The non-folded part 10a, 11a, 12a and 13a is perpendicular to the earth plane.

The length of the folded part of each antenna represents between 25% and 40% of the total length of the antenna, which is for example 70 mm. Preferentially, the length of the folded part of each antenna represents 30% of the total length of the antenna.

Each antenna is symmetrical with another antenna in accordance with a central symmetry, the centre of the symmetry being a point above the earth plane at the same distance as the distance separating the antennas from the earth plane.

Each antenna is placed above the earth plane at a position such that the distance from its symmetrical antenna is the greatest.

The earth plane comprises four openings; only three, denoted 14, 15 and 16 are visible in FIG. 1.

Each opening is symmetrical with another opening in accordance with the same centre of symmetry as that of the antennas.

FIG. 2 shows a longitudinal section of two antennas symmetrical with respect to a point.

The two antennas are folded three times. Naturally the antennas may be folded a greater number of times.

The folds are denoted 21a, 21b and 21c for one of the antennas and denoted 20a, 20b and 20c for the other antenna.

FIG. 3 shows an example embodiment of a multi-antenna system that comprises an odd number of antennas.

In the example of FIG. 3, the multi-antenna system comprises seven antennas. The antennas have the same form and the same size.

The antennas 30 to 36 have an elliptical shape and are placed above the earth plane at a distance of 1 to 4 mm from the earth plane. In a variant, the antennas have a circular, triangular, trapezoidal or elliptical shape.

The antennas are connected respectively to a modem represented by a sinusoid in a circle.

The antennas 30 to 36 are folded in the same way as that described with reference to FIG. 1.

The antenna 36 is placed at a point above the earth plane at the same distance from the earth plane as the distance of the other antennas from the earth plane and each antenna 30 to 35 is symmetrical with another antenna according to a central symmetry, the centre of the symmetry being the point at which the antenna 36 is placed.

Each antenna 30 to 35 is placed above the earth plane at a position such that the distance from its symmetrical antenna is the greatest.

For example, the antenna 36 is dedicated to communications in the frequency band reserved for WiFi or Zigbee or Bluetooth while the antennas 30 to 35 are dedicated to communications at the frequency bands reserved for the cellular telecommunication standards 2G, 3G, UMTS, CDMA, 4G LTE and ISM.

Naturally the present invention is in no way limited to the embodiments described here but quite the contrary encompasses any variant within the capability of a person skilled in the art and particularly the combination of various embodiments of the present invention.

1. Multi-antenna broadband system comprising:
at least two antennas with the same shape and same size, placed above an earth plane, wherein:
the antennas are connected respectively to a modem, and
the part most distant from the earth plane of each antenna is folded one or more times so that the folded part or the last folded part of the antenna forms an angle with the non-folded part of the antenna of between 10° and 100°.

2. The multi-antenna system according to claim 1, wherein that each antenna is folded once and the length of the folded part represents between 25% and 40% of the total length of the antenna.

3. The multi-antenna system according to claim 1, wherein each antenna is placed above the earth plane at the same distance from the earth plane.

4. The multi-antenna system according to claim 1, wherein the multi-antenna system comprises an even number of antennas, and each antenna is symmetrical with another antenna according to a central symmetry, the centre of the symmetry being a point above the earth plane at the same distance as the distance separating the antennas from the earth plane.

5. The multi-antenna system according to claim 4, wherein each antenna is placed above the earth plane at a position such that the distance from its symmetrical antenna is the greatest.

6. The multi-antenna system according to claim 1, wherein the multi-antenna system comprises an odd number of antennas comprising a first antenna and second antennas, the first antenna being placed at a point above the earth plane at the same distance from the earth plane as the distance from the second antennas to the earth plane and each second antenna is symmetrical with another second antenna in accordance with a central symmetry, the centre of the symmetry being the point at which the first antenna is placed.

7. The multi-antenna system according to claim 6, wherein each second antenna is placed above the earth plane at a position such that the distance from its symmetrical antenna is the greatest.

8. The multi-antenna system according to claim 1, wherein the antennas have a circular, triangular, trapezoidal or elliptical shape and are placed above the earth plane at a distance of 1 to 4 mm from the earth plane.

9. The multi-antenna system according to claim 8, wherein the shape is elliptical and the total length of the antenna is 70 mm.
